(19) United States
(12) Patent Application Publication
(10) Pub. No.: US 2025/0087928 A1
(43) Pub. Date: Mar. 13, 2025

(54) LIGHT-BLOCKING RECEPTACLE ELECTRICAL CONNECTOR

(71) Applicant: Amphenol East Asia Electronic Technology (Shenzhen) Co., Ltd., Shenzhen (CN)

(72) Inventors: Kangqin Li, Shenzhen (CN); Zhimin Qin, Shenzhen (CN)

(73) Assignee: Amphenol East Asia Electronic Technology (Shenzhen) Co., Ltd., Shenzhen (CN)

(21) Appl. No.: 18/823,968

(22) Filed: Sep. 4, 2024

(30) Foreign Application Priority Data
Sep. 8, 2023 (CN) 202322453812.9

(51) Int. Cl. H01R 13/502; H01R 13/506

(52) U.S. Cl. CPC H01R 13/5025; H01R 13/506

(57) ABSTRACT

A light-blocking receptacle connector for use in an electronic device including a main shell and a terminal subassembly disposed therein. The main shell includes one or more engaging portions extending from walls towards inside the main shell. The engaging portions are configured to engage a mating connector and/or a subassembly housing. Gaps exist between the engaging portions and walls. A member is disposed outside the main shell and configured for blocking light from exiting the main shell through a front opening and/or a port of a device chassis in which the connector is disposed. The member can include one or more films overlapping with the engaging portions and associated gaps and/or an outer shell disposed outside the main shell. A front portion of the outer shell can overlap with the engaging portions and associated gaps and/or be disposed outside the films. The front portion may include bulges that deflect light.

### CROSS-REFERENCE TO RELATED APPLICATIONS

This application claims priority to and the benefit of Chinese Patent Application Serial No. 202322453812.9, filed on Sep. 8, 2023, the contents of which are incorporated herein by reference in their entirety.

### TECHNICAL FIELD

This application relates to interconnection systems, such as those including electrical connectors, configured to interconnect electronic assemblies.

### BACKGROUND

Electrical connectors are used in many electronic systems. It is generally easier and more cost effective to manufacture a system as separate electronic subassemblies, such as printed circuit boards (PCBs), which may be joined together with electrical connectors. Having separable connectors enables components of the electronic system manufactured by different manufacturers to be readily assembled. Separable connectors also enable components to be readily replaced after the system is assembled, either to replace defective components or to upgrade the system with higher performance components.

A known arrangement for joining several electronic subassemblies is to have one printed circuit board serve as a backplane. A known backplane is a PCB onto which many connectors may be mounted. Conducting traces in the backplane may be electrically connected to signal conductors in the connectors such that signals may be routed between the connectors. Other printed circuit boards, called “daughterboards,” “daughtercards,” or “midboards,” may be connected through the backplane. For example, daughtercards may also have connectors mounted thereon. The connectors mounted on a daughtercard may be plugged into the connectors mounted on the backplane. In this way, signals may be routed among daughtercards through the connectors and the backplane. The daughtercards may plug into the backplane at a right angle. The connectors used for these applications may therefore include a right angle bend and are often called “right angle connectors.”

Connectors may also be used in other configurations for interconnecting electronic assemblies. Sometimes, one or more printed circuit boards may be connected to another printed circuit board, called a “motherboard,” that is both populated with electronic components and interconnects the daughterboards. In such a configuration, the printed circuit boards connected to the motherboard may be called daughterboards. The daughterboards are often smaller than the motherboard and may sometimes be aligned parallel to the motherboard. Connectors used for this configuration are often called “stacking connectors” or “mezzanine connectors.” In other systems, the daughterboards may be perpendicular to the motherboard.

Connectors may also be used in computers in which the motherboard might have a processor and a bus configured to pass data between the processor and peripherals, such as a printer or memory device. Connectors may be mounted to the motherboard and connected to the bus. A mating interface of those connectors may be exposed through an opening in the enclosure for the computer, such that connectors, often attached to the peripheral through a cable, may be inserted into the connectors on the motherboard. With this configuration, a peripheral can be easily connected to a computer.

To enhance the availability of peripherals, the bus and the connectors used to physically connect peripherals via the bus may be standardized. In this way, there may be a large number of peripherals available from a multitude of manufacturers. All of those products, so long as they are compliant with the standard, may be used in a computer that has a bus compliant with the standard. Examples of such standards include universal serial bus (USB), which is commonly used in computers. The standards have gone through multiple revisions, adapting to the higher performance expected from computers over time. For example, portable electronic devices often include USB Type-C receptacle connectors for various purposes such as charging and/or exchanging data with another electronic device by connecting the USB receptacle connector with a USB plug connector.

### BRIEF SUMMARY

Aspects of the present application relate to light-blocking receptacle electrical connectors.

Some embodiments relate to a receptacle connector configured for use in an electronic device. The receptacle connector may comprise a main shell comprising a cavity with a front opening, a first wall, a first engaging portion connected to the first wall and protruding towards the cavity and configured to engage a mating connector, and a first gap between the first wall and the first engaging portion; a terminal subassembly disposed in the cavity of the main shell, the terminal subassembly comprising a subassembly housing and a plurality of conductive elements held by the subassembly housing, each of the plurality of conductive elements comprising a mating end, a tail end extending out of the subassembly housing, and an intermediate portion between the mating end and the tail end; and a member disposed outside the main shell and configured for blocking light from exiting the main shell through the front opening.

Optionally, the member comprises a film overlapping with the first engaging portion and the first gap.

Optionally, the film is a MYLAR sheet.

Optionally, the member comprises an outer shell having a front portion disposed outside the film.

Optionally, the main shell comprises a second engaging portion connected to the first wall and protruding toward inside the main shell, and a second gap between the first wall and the second engaging portion; and the film overlaps with the second engaging portion and the second gap.

Optionally, the subassembly housing comprises a first accommodation portion configured for engaging the second engaging portion of the main shell; and the first accommodation portion is disposed closer to the mating ends of the plurality of conductive elements than the tail ends of the plurality of conductive elements.

Optionally, the front portion of the outer shell comprises a bulge disposed closer to the mating ends of the plurality of conductive elements than the first accommodation portion of the subassembly housing.

Optionally, the bulge comprises a guiding portion extending towards outside the outer shell and extending obliquely towards a rear end of the outer shell, and a slanting portion extending towards outside the outer shell and extending obliquely towards a front end of the outer shell and joining the guiding portion.

Optionally, the first engaging portion of the main shell comprises a first beam having a proximal end connected to the first wall and a distal end configured to engage the mating connector; the second engaging portion of the main shell comprises a second beam configured for engaging the first accommodation portion and a third beam disposed closer to the tail ends of the plurality of conductive elements than the second beam; and the subassembly housing comprises a second accommodation portion configured for engaging the third beam.

Optionally, the front portion of the outer shell encloses a respective portion of the main shell and comprises a plurality of bulges.

Some embodiments relate to an electronic system. The electronic system may comprise a chassis comprising a port, and the receptacle connector described herein, the receptacle connector disposed in the chassis, wherein the member may be configured for blocking light from exiting the chassis through the port.

Some embodiments relate to a receptacle connector configured for use in an electronic device. The receptacle connector may comprise a main shell comprising a first wall, a first engaging portion connected to the first wall and protruding towards inside the main shell and configured to engage a mating connector, a first gap between the first wall and the first engaging portion, a second engaging portion connected to the first wall and protruding towards inside the main shell, and a second gap between the first wall and the second engaging portion; a terminal subassembly disposed in the main shell, the terminal subassembly comprising a subassembly housing and a plurality of conductive elements held by the subassembly housing, each of the plurality of conductive elements comprising a mating end, a tail end extending out of the subassembly housing, and an intermediate portion between the mating end and the tail end, the subassembly housing comprising a first accommodation portion disposed closer to the mating ends of the plurality of conductive elements than the tail ends of the plurality of conductive elements, the first accommodation portion configured for engaging the second engaging portion of the main shell; and an outer shell comprising a front portion disposed outside the first engaging portion of the main shell and comprising a plurality of bulges extending towards outside the outer shell.

Optionally, each of the plurality of bulges of the outer shell comprises a guiding portion extending towards a rear end of the outer shell, and a slanting portion extending towards a front end of the outer shell and joining the guiding portion.

Optionally, the first engaging portion is aligned with respective bulges of the plurality of bulges in a vertical direction perpendicular to a mating direction of the receptacle connector.

Optionally, the plurality of bulges are disposed closer to the mating ends of the plurality of conductive elements than the first accommodation portion of the subassembly housing in the mating direction of the receptacle connector.

Optionally, the main shell comprises a second wall opposite the first wall; the first engaging portion comprises portions extending from the first and second walls, respectively; and the receptacle connector further comprises a first film disposed between the portion of the first engaging portion extending from the first wall of the main shell and the front portion of the outer shell, and a second film disposed between the portion of the first engaging portion extending from the second wall of the main shell and the front portion of the outer shell.

Optionally, the first and second films are MYLAR sheets.

Optionally, the second engaging portion comprises portions extending from the first and second walls, respectively; the first film is disposed between the portion of the second engaging portion extending from the first wall of the main shell and the front portion of the outer shell; and the second film is disposed between the portion of the second engaging portion extending from the second wall of the main shell and the front portion of the outer shell.

Some embodiments relate to a method of manufacturing a receptacle connector. The method may comprise providing a terminal subassembly comprising a plurality of conductive elements held by a subassembly housing, each of the plurality of conductive elements comprising a mating end, a tail end extending out of the subassembly housing, and an intermediate portion between the mating end and the tail end, the subassembly housing comprising a first accommodation portion disposed closer to the mating ends of the plurality of conductive elements than the tail ends of the plurality of conductive elements; providing a main shell comprising a first wall, a first engaging portion connected to the first wall and protruding towards inside the main shell and configured to engage a mating connector, a first gap between the first wall and the first engaging portion, a second engaging portion connected to the first wall and protruding towards inside the main shell, and a second gap between the first wall and the second engaging portion; disposing the terminal subassembly in the main shell such that the first accommodation portion of the subassembly housing engages the second engaging portion of the main shell; and disposing a film on the first wall of the main shell such that the film overlaps with the first and second engaging portions and the first and second gaps.

Optionally, the method may further comprise providing an outer shell comprising a front portion having a bulge; and disposing the outer shell outside the main shell such that the bulge of the front portion is substantially aligned with the first engaging portion in a vertical direction perpendicular to a mating direction of the receptacle connector.

Some embodiments relate to an electrical connector. The electrical connector may comprise a terminal subassembly and a main shell. The terminal subassembly may include a plurality of conductive elements and a subassembly housing holding the conductive elements. The subassembly housing may be molded over the conductive elements. The main shell may comprise a body enclosing a cavity. The main shell may be sleeved on an outer side of the terminal subassembly. The body of the main shell may include first engaging portions configured for engaging with a mating electrical connector in a mating direction. The first engaging portions may extend from a first main shell sidewall and/or a second main shell sidewall opposite to each other in a vertical direction perpendicular to the mating direction. The first engaging portions may protrude from the first main shell sidewall and/or the second main shell sidewall towards the cavity of the main shell. The first engaging portions may be partially separated from the first main shell sidewall and/or the second main shell sidewall of the main shell. The electrical connector may further comprise a member disposed on an outer side of the main shell and configured for blocking the first engaging portions.

Optionally, the member may include a blocking film which may be disposed on an outer surface of the first main shell sidewall and/or the second main shell sidewall of the main shell.

Optionally, the member may further include an outer shell which may be sleeved on the outer side of the main shell and cover at least a portion of the blocking film.

Optionally, the first engaging portions may comprise first beams which may be configured to extend obliquely from the first main shell sidewall and/or the second main shell sidewall of the body of the main shell towards the cavity of the main shell, the first beams are configured to have distal ends separated from the first main shell sidewall and/or the second main shell sidewall, forming a gap between the first beams and the first main shell sidewall and/or the second main shell sidewall.

Optionally, the body of the main shell may be configured to have at least one second engaging portion, the main shell may be secured in place at the outer side of the terminal subassembly by engaging the second engaging portion with a corresponding accommodation portion of the subassembly housing, the second engaging portion may be formed integrally with the main shell.

Optionally, the second engaging portion may include at least one second beam which may extend from the first main shell sidewall and/or the second main shell sidewall, the second beam may be recessed from the first main shell sidewall and/or the second main shell sidewall towards the cavity of the main shell, such that the second beam may be partially separated from the first main shell sidewall and/or the second main shell sidewall, forming a gap between the second beam and the first main shell sidewall and/or the second main shell sidewall.

Optionally, the second beam may be configured to be accommodated in a first accommodation portion formed adjacent a mating end of the subassembly housing of the terminal subassembly, thereby positioning the main shell on the outer side of the terminal subassembly.

Optionally, the second engaging portion may include third beams configured to be provided at a tail end of the main shell, the third beams may be opposite to each other in a transverse direction perpendicular to both the mating direction and the vertical direction, the third beams may be engaged with a second accommodation portion formed in the tail end of the subassembly housing of the terminal subassembly in a snap-fit manner, so that the main shell can be fixedly sleeved on the outer side of the terminal subassembly.

Optionally, the blocking film may be configured to have a shape and dimension configured to overlap with the first engaging portions and the second beam.

Optionally, an outer shell sleeved on the outer side of the main shell and configured to overlap with at least a portion of the blocking film.

Optionally, in the mating direction, a mating end of the main shell may extend beyond a mating end of the outer shell, the mating end of the outer shell may be disposed on a mating end of the blocking film.

Optionally, a wall of the outer shell corresponding to the first main shell sidewall and/or the second main shell sidewall of the main shell may comprise at least one bulge, and the bulge may overlap with the first engaging portions of the main shell.

Optionally, the bulge may comprise a slanting portion which may extend obliquely from the wall of the outer shell outwardly and towards a front end of the outer shell, forming a gap between the outer shell and the blocking film.

Optionally, the bulge may comprise a guiding portion which may extend obliquely from the wall of the outer shell outwardly and towards a rear end of the outer shell, the guiding portion may join the slanting portion, forming a predetermined angle therewith.

Optionally, the member may comprise an outer shell sleeved on the outer side of the main shell.

Optionally, the body of the main shell may be configured to have at least one second engaging portion, the main shell may be secured in place at the outer side of the terminal subassembly by engaging the second engaging portion with a corresponding accommodation portion of the subassembly housing, the second engaging portion may be formed integrally with the main shell.

Optionally, the second engaging portion may include at least one second beam extending from the first main shell sidewall and/or the second main shell sidewall, the second beam may be recessed from the first main shell sidewall and/or the second main shell sidewall towards the cavity of the main shell, such that the second beam can be partially separated from the first main shell sidewall and/or the second main shell sidewall, forming a gap between the second beam and the first main shell sidewall and/or the second main shell sidewall.

Optionally, the second beam may be configured to be accommodated in a first accommodation portion formed adjacent a mating end of the subassembly housing of the terminal subassembly, thereby positioning the main shell on the outer side of the terminal subassembly.

Optionally, the second engaging portion may comprise third beams configured to be provided at a tail end of the main shell, the third beams may be opposite to each other in a transverse direction perpendicular to both the mating direction and the vertical direction, the third beams may be engaged with a second accommodation portion formed in the tail end of the subassembly housing of the terminal subassembly in a snap-fit manner, so that the main shell can be fixedly sleeved on the outer side of the terminal subassembly.

Optionally, in the mating direction, a mating end of the main shell may extend beyond a mating end of the outer shell, the first engaging portions and the second beam of the main shell can overlap with the outer shell.

Optionally, the outer shell may comprise a first portion, a second portion, and an intermediate connecting portion connecting the first portion with the second portion, the first portion may include, in the vertical direction, a first wall and a second wall opposite to the first wall, the first wall and the second wall may be configured to have shapes and dimensions configured to overlap with the first engaging portions and the second beam.

Optionally, at least one of the first wall and the second wall may include at least one bulge protruding outwardly, the bulge may comprise a slanting portion extending obliquely from a corresponding one of the first wall and the second wall outwardly and towards a front end of the outer shell, forming a gap between the outer shell and the first engaging portions.

Optionally, the bulge may comprise a guiding portion extending from a corresponding one of the first wall and the second wall outwardly and towards the rear end of the outer shell, the guiding portion may join the slanting portion, forming a predetermined angle therewith.

Optionally, the first portion may include a first outer shell sidewall and a second outer shell sidewall opposite to each other and extending downwardly in a vertical direction respectively from ends of the first wall in a transverse direction perpendicular to the mating direction and the vertical direction, each of the first outer shell sidewall and the second outer shell sidewall may include a protrusion.

Optionally, openings may be formed adjacent ends of the second portion in the transverse direction; the intermediate connecting portion may extend in a circular arc from a tail end of the first wall to allow the opening of the second portion to engage with the protrusion in a snap-fit manner.

Some embodiments relate to an electronic system. The electronic system may comprise a chassis and an electrical connector described herein. The chassis may include a port. A mating end of the main shell of the electrical connector may be at least partially disposed in the port of the chassis such that the mating end of the terminal subassembly of the electrical connector can be exposed through the port of the chassis.

These techniques may be used alone or in any suitable combination. The foregoing summaries are provided by way of illustration and are not intended to be limiting.

### BRIEF DESCRIPTION OF DRAWINGS

The accompanying drawings may not be drawn to scale. In the drawings, each identical or nearly identical component that is illustrated in various figures may be represented by a like numeral. For purposes of clarity, not every component may be labeled in every drawing. In the drawings:

FIG. 1 is a top, front perspective view of an electrical connector, according to some embodiments;

FIG. 2 is a partially exploded perspective view of the electrical connector of FIG. 1;

FIG. 3 is a perspective view of a main shell of the electrical connector of FIG. 1;

FIG. 4 is a rear perspective view of the electrical connector of FIG. 1, showing the main shell and the terminal subassembly;

FIG. 5 is a cross-sectional view of the electrical connector of FIG. 1, taken along a line marked “A-A” in FIG. 1;

FIG. 6 is a perspective view of an electrical connector, according to some embodiments;

FIG. 7 is a cross-sectional view of the electrical connector of FIG. 6, taken along line a line marked “B-B” in FIG. 6;

FIG. 8 is a top, front perspective view of an outer shell of the electrical connector of FIG. 6;

FIG. 9 is a top, rear perspective view of the outer shell of FIG. 8;

FIG. 10 is a rear perspective view of an electronic system, according to some embodiments; and

FIG. 11 is a cross-sectional view of the electronic system of FIG. 10, taken along a line marked “C-C” in FIG. 10.

### DETAILED DESCRIPTION

The inventors have recognized and appreciated techniques for making light-blocking receptacle electrical connectors. A receptacle connector may be integrated inside a chassis of an electronic device and configured to receive a mating component, such as a plug connector, to enable the electronic device to connect with other devices. Such electronic devices may include cell phones, smart watches, tablet PCs, photographic equipment, game consoles, routers, electric pens, electronic cigarettes, portable monitoring devices, etc. Conventional connector designs may be assembled with components that have openings and/or gaps therebetween.

Many electronic devices include LEDs or other light sources (e.g., a backlight panel) intended to be visible to a user in specific ways or at specific times. Light from inside an electronic device, however, can leak through the openings and/or gaps to outside the electronic device where that light is visible to a user. Such leaked light can cause various issues such as confusing a user of the electronic device, bring discomfort to a user of the electronic device in a dark environment (e.g., when the electronic device is charging or exchanging data with other electronic devices at night), etc.

Techniques described herein can enhance the experience for users of electronic devices by providing receptacle connectors that block light from inside an electronic device from passing through gaps in the connector components and then passing through an opening of an electronic enclosure in which the connector is mounted. These components might be integrated into the connector such that the connector is compact and robust.

These techniques may include application of a thin sheet of material over one or more surfaces of a connector shell so as to restrict light passing through gaps that result from forming components integrally with the shell. The thin sheets of material may be films, such as polymer films. As another example, such techniques may alternatively or additionally include structures that deflect light away from the opening of the enclosure. These components may be positioned in the path of light passing through a gap in the connector to the exterior of the enclosure.

Such techniques are illustrated herein as applied to a USB Type-C right-angle receptacle connector, but may be applied in other types of connectors.

In one example, a light-blocking receptacle connector for use in an electronic device can include a main shell and a terminal subassembly disposed in the main shell. The main shell may include one or more engaging portions extending from walls towards inside the main shell. Some engaging portions may be configured to engage a mating connector. Some other engaging portions may be configured to engage a subassembly housing of the terminal subassembly and thus secure the terminal subassembly in the main shell. Gaps may exist between the engaging portions and corresponding walls.

A member can be disposed outside the main shell and configured for blocking light from exiting the main shell through a front opening and/or a port of a device chassis in which the connector is disposed. “Blocking” may refer to a reduction of light, but not necessarily eliminate it entirely. In some embodiments, the member can include one or more films overlapping with the engaging portions and associated gaps. The film may be a MYLAR sheet or any suitable material. In some embodiments, the member can include an outer shell. In some embodiments, a front portion of the outer shell can be disposed outside the films. In some embodiments, a front portion of the outer shell can be directly disposed outside the main shell.

The outer shell may include a front portion having bulges that can deflect light. Each bulge may include a guiding portion and a slanting portion joining the guiding portion. Both the guiding portion and the slanting portion may extend towards outside the outer shell, with the guiding portion extending obliquely towards a rear end of the outer shell and the slanting portion extending obliquely towards a front end of the outer shell. For example, when light from inside an electronic device towards a port of the device chassis, the slanting portion may reflect the light to inside the device chassis, and/or the guiding portion may reflect the light to a panel of the device chassis which can then reflect the light to inside the device chassis, blocking the light from exiting the device chassis through the port and/or a mating opening of the connector.

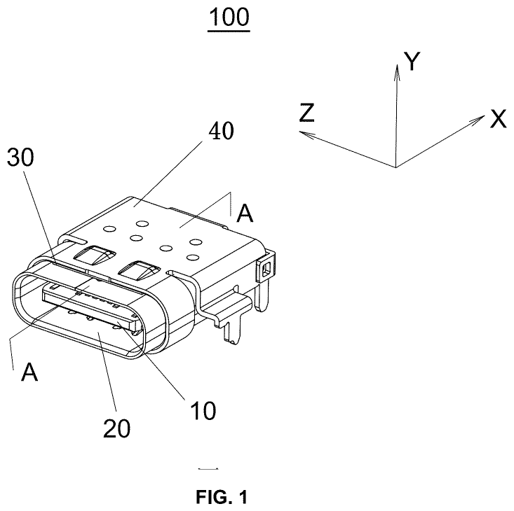

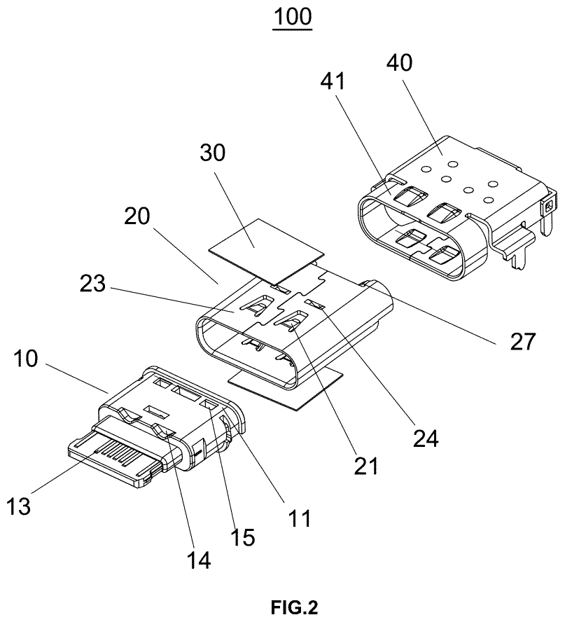

Referring to FIG. 1 and FIG. 2, according to aspects of the present disclosure, an electrical connector 100 may comprise a terminal subassembly 10, a main shell 20, and a member configured to block light from exiting a mating end of the connector 100. The terminal subassembly 10 may include a plurality of conductive elements 13 and a subassembly housing 11 holding the conductive elements. The subassembly housing 11 may be molded over the conductive elements 13. The main shell 20 may comprise a body 23 enclosing a cavity. The body 23 may be sleeved on an outer side of the terminal subassembly 10. The body 23 of the main shell 20 may include first engaging portions configured for engaging with a mating electrical connector in a mating direction X. The first engaging portions may extend from a first main shell sidewall 22 and/or a second main shell sidewall 28 opposite to each other in a vertical direction Y perpendicular to the mating direction X. The first engaging portions may protrude from the first main shell sidewall 22 and/or the second main shell sidewall 28 of the main shell 20 towards the cavity of the main shell 20. The first engaging portions may be partially separated from the first main shell sidewall 22 and/or the second main shell sidewall 28 of the main shell 20. The member may be disposed on an outer side of the main shell 20. The member may overlap with the first engaging portions.

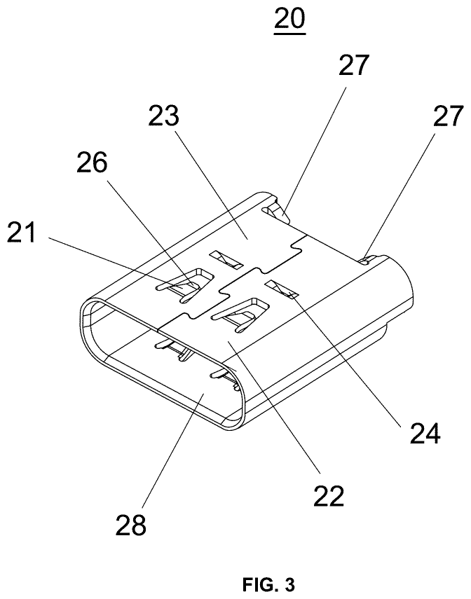

In some embodiments, referring to FIG. 3, the first engaging portions of the main shell 20 may comprise first beams 21 configured to extend obliquely from the first main shell sidewall 22 and/or the second main shell sidewall 28 of the body 23 of the main shell 20 towards the cavity of the main shell 20. The first beams 21 may be configured to have distal ends 26 separated from the first main shell sidewall 22 and/or the second main shell sidewall 28, forming a gap between the first beams 21 and the first main shell sidewall 22 and/or the second main shell sidewall 28. In some embodiments, the first beam 21 may be shaped into a tongue shape and be capable of deforming under an external force.

In some embodiments, the body 23 of the main shell 20 may be configured to have at least one second engaging portion. The main shell 20 may be secured in place at an outer side of the terminal subassembly 10 by engaging the second engaging portion with a corresponding accommodation portion of the subassembly housing 11. In some embodiments, the second engaging portion may be formed integrally with the main shell 20.

In some embodiments, the accommodation portion may include a first accommodation portion 14 formed adjacent a mating end of the subassembly housing 11 of the terminal subassembly 10 and a second accommodation portion 15 formed adjacent a tail end of the subassembly housing 11 of the terminal subassembly 10.

In some embodiments, as shown in FIG. 3, the second engaging portion may include at least one second beam 24 extending from the first main shell sidewall 22 and/or the second main shell sidewall 28 of the main shell. The second beam 24 may be recessed from the first main shell sidewall 22 and/or the second main shell sidewall 28 of the body 23 of the main shell 20 towards the cavity of the main shell 20, such that the second beam 24 may be partially separated from the first main shell sidewall 22 and/or the second main shell sidewall 28, forming a gap between the second beam 24 and the first main shell sidewall 22 and/or the second main shell sidewall 28.

In some embodiments, the second beam 24 may be configured to be accommodated in a first accommodation portion 14 formed adjacent the mating end of the subassembly housing 11 of the terminal subassembly 10, positioning the main shell 20 on an outer side of the terminal subassembly 10.

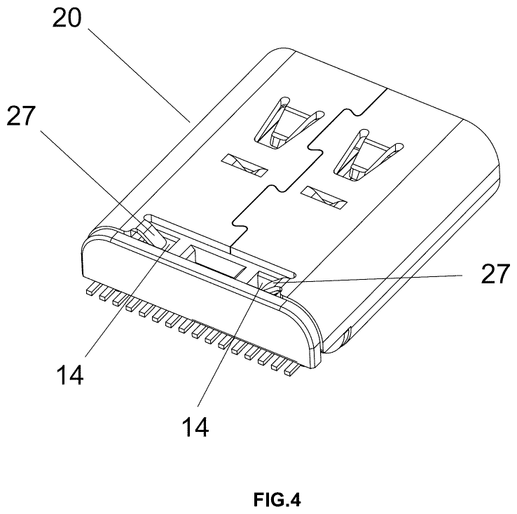

In some embodiments, as shown in FIG. 3 and FIG. 4, the second engaging portion may include third beams 27 configured to be provided at a tail end of the main shell 20. The third beams 27 may be opposite to each other in a transverse direction, and the third beams 27 may be engaged with a second accommodation portion 15 formed in the tail end of the subassembly housing 11 of the terminal subassembly 10 in a snap-fit manner, so that the main shell 20 can be fixedly sleeved on the outer side of the terminal subassembly 10.

In some embodiments, when the electrical connector and a mating electrical connector are mated with each other, the mating portion of the mating electrical connector may slide against the first engaging portions of the main shell of the electrical connector such that the first engaging portions can be deformed in the vertical direction until the mating portion of the mating electrical connector may abut against the second beam of the first accommodation portion accommodated in the accommodation portion of the terminal subassembly. For example, the first engaging portions and the second beam of the main shell limit a position of the mating portion of the mating electrical connector, thus enabling precise control of a plugging depth of the mating portion and avoiding an excessive plugging or insufficient plugging.

Furthermore, the third beams 27 of the main shell 20 may be engaged with the second accommodation portion of the terminal subassembly 10 so that the main shell can be fixed with respect to the subassembly housing of the terminal subassembly, thereby effectively preventing the main shell from displacing with respect to the terminal subassembly along the mating direction X. In addition, since the main shell and the second engaging portion according to the present application may be formed integrally, in other words, since the second engaging portion is a part of the main shell, no additional attachment components for attaching the main shell to the terminal subassembly are required, which reduces the number of components of the electrical connector, simplifies the manufacturing process, enabling a compact structure while also improving the durability of the electrical connector. Thus the contact stability and the connection reliability between the mating connector and the electrical connector are improved.

In some embodiments, the third beams 27 may bend toward the inside of the main shell 20 in the assembled state of the electrical connector to engage with the second accommodation portion 15. In some embodiments, the main shell can bend and deform. For example, the main shell may be made of metal.

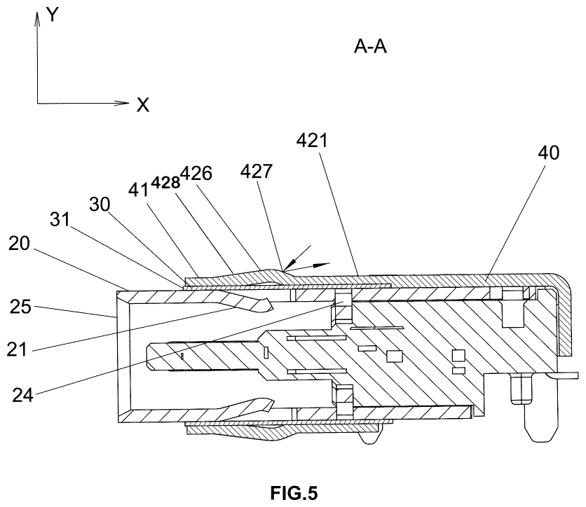

In some embodiments, as shown in FIG. 2, the member may include a blocking film 30 (e.g., a MYLAR sheet or any suitable material) attached to an outer surface of the first main shell sidewall 22 and/or the second main shell sidewall 28 of the main shell 20. The MYLAR sheet 30 may be configured to have a shape and dimension configured to overlap with the first engaging portions and the second beam. For example, referring to FIG. 5, the MYLAR sheet 30 can overlap with the gap formed between the first engaging portions and the body as well as the gap formed between the second beam and the body. In this case, light from the backlight panel of the electronic device can be blocked by the MYLAR sheet 30, thereby providing a blocking effect for the electrical connector 100. A MYLAR sheet is a high-performance plastic film made from polyester, with typical thicknesses ranging from 20 to 100 microns. The opacity of the film varies with its thickness. The MYLAR sheet 30 may have a thickness towards the upper end of this range to block more light.

In some embodiments, the MYLAR sheet 30 may be formed into a rectangular shape, as shown in FIG. 2. However, it will be appreciated by those skilled in the art that the MYLAR sheet may be formed into any shapes as long as it is capable of configured for blocking the first engaging portions and the second beam.

In some embodiments, the MYLAR sheet may be formed from a polycarbonate film or a polyethylene terephthalate (PET) film. In some embodiments, the MYLAR sheet is characterized by dimensional stability as well as tearing-resistant strength. Thus, in some embodiments of the present application, the MYLAR sheet cannot be easily deformed during assembly. In some embodiments, the MYLAR sheet formed from the polyester film may be formed by stamping.

In some embodiments, the MYLAR sheet can be directly attached to the sidewall of the main shell due to its own adhesive properties. As a result, other adhesives may not be needed in the process of assembling the MYLAR sheet to the main shell, thereby simplifying manufacturing.

In some embodiments, referring to FIG. 2 and FIG. 5, the member may further include an outer shell 40 sleeved on an outer side of the main shell 20 and configured to overlap with at least a portion of the MYLAR sheet 30. Thus, when the electrical connector is assembled to the electronic device, light from the backlight panel of the electronic device can be further blocked by the outer shell 40.

In some embodiments, as shown in FIG. 5, in the mating direction X, a mating end 25 of the main shell 20 may extend beyond a mating end 41 of the outer shell 40. The mating end 41 of the outer shell 40 may be disposed outside a mating end 31 of the MYLAR sheet 30.

In some embodiments, as shown in FIG. 5, at least one bulge 426 protruding towards an outer side of the outer shell may be formed on a wall of the outer shell 40 corresponding to the first main shell sidewall 22 and the second main shell sidewall 28 of the main shell 20. The bulge 426 may overlap with the first engaging portions of the main shell 20. In some embodiments, the wall may include, in the vertical direction Y, a first wall 421 and a second wall 422 opposite to the first wall 421.

In some embodiments, the bulge 426 may comprise a slanting portion 427 extending obliquely from the wall of the outer shell 40 outwardly and towards a front end of the outer shell 40, forming a gap between the outer shell 40 and the MYLAR sheet 30, as shown in FIG. 5. When light from the electronic device illuminates the outer shell 40, the slanting portion 427 reflects the light to the inside of the electronic device (see, e.g., the arrows shown in FIG. 5), thereby preventing light from the electronic device from passing through the electrical connector and leaking to the outside.

In some embodiments, the outer shell having the bulge may not only overlap with the first engaging portions so that the light from the inside of the electronic device cannot leak outside the electrical connector through the gap between the first engaging portions and the body, but also may reflect the light from the electronic device to the inside of the electronic device, thereby further improving the light blocking effect for the electrical connector.

In some embodiments, the bulge 426 may comprise a guiding portion 428 extending obliquely from the wall outwardly and towards the rear end of the outer shell 40. The guiding portion 428 may join the slanting portion 427, forming a predetermined angle therewith.

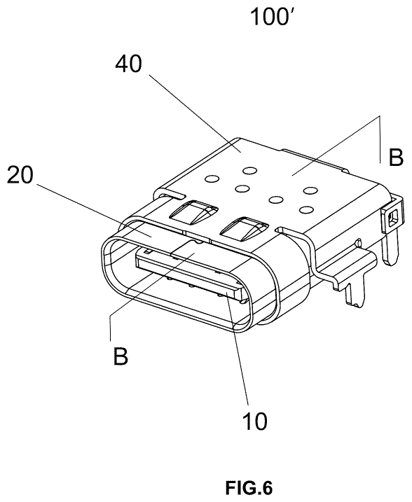

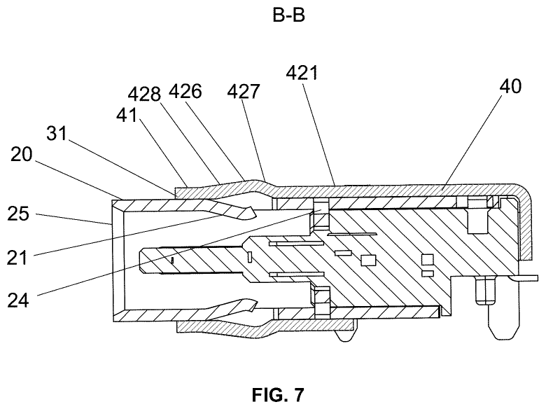

Referring to FIG. 6 and FIG. 7, in some embodiments, an electrical connector 100′ may share features with the electrical connector 100 described above. Features of the electrical connector 100′ that are similar to that of the electrical connector 100 may not be repeated below.

The electrical connector 100′ may include the outer shell 40 directly sleeved on the outer side of the main shell 20. In some embodiments, referring to FIG. 7, in the mating direction X, a mating end 25 of the main shell 20 may extend beyond a mating end 41 of the outer shell 40. The first engaging portions and the second beam 24 of the main shell 20 may overlap with the outer shell 40 so as to overlap with the gap between the first engaging portions and the first main shell sidewall 22 and/or the second main shell sidewall 28 as well as the gap between the second beam 24 and the first main shell sidewall 22 and/or the second main shell sidewall 28.

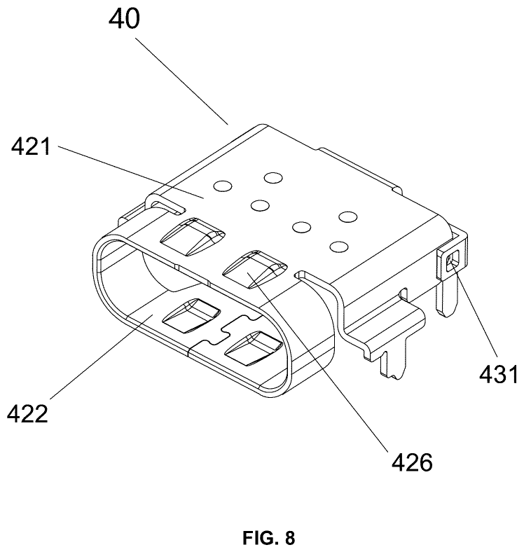

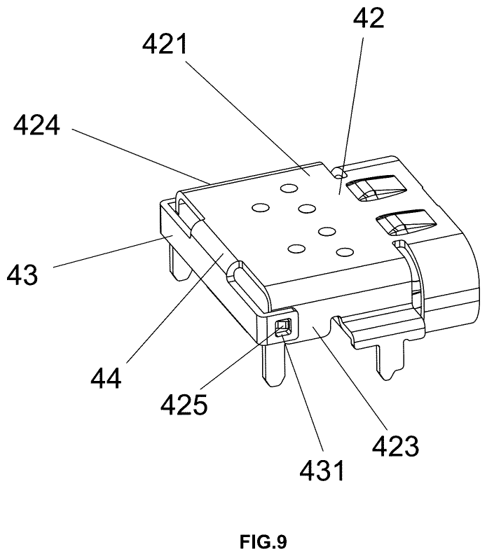

In some embodiments, referring to FIG. 8 and FIG. 9, the outer shell 40 may comprise a first portion 42, a second portion 43, and an intermediate connecting portion 44 connecting the first portion 42 with the second portion 43. The first portion 42 may include, in the vertical direction Y, a first wall 421 and a second wall 422 opposite to the first wall 421. The first wall 421 and the second wall 422 may be configured to have shapes and dimensions configured to overlap with the first engaging portions and the second beam.

In some embodiments, at least one of the first wall 421 and the second wall 422 may include at least one bulge 426 protruding towards an outer side of the outer shell 40. The bulge 426 may comprise a slanting portion 427 (referring to FIG. 7) extending obliquely from a corresponding one of the first wall 421 and the second wall 422 outwardly and towards a front end of the outer shell 40, forming a gap between the outer shell 40 and the first engaging portions. The slanting portion 427 may be used to reflect light illuminating the outer shell to the inside of the electronic device, thereby preventing light from leaking outside the electrical connector.

In some embodiments, the bulge 426 may comprise a guiding portion 428 extending from a corresponding one of the first wall 421 and the second wall 422 outwardly and towards the tail end of the outer shell 40. The guiding portion 428 may join the slanting portion 427, forming a predetermined angle therewith.

In some embodiments, the first portion 42 may include a first outer shell sidewall 423 and a second outer shell sidewall 424 opposite to each other and extending downwardly in a vertical direction Y respectively from ends of the first wall 421 in a transverse direction Z. Each of the first outer shell sidewall 423 and the second outer shell sidewall 424 may include a protrusion 425.

In some embodiments, openings 431 may be formed adjacent ends of the second portion 43 in the transverse direction Z. The intermediate connecting portion 44 may extend in a circular arc from a tail end of the first wall 421 to allow the openings 431 of the second portion 43 to engage with the protrusion 425 of the first portion 42 in a snap-fit manner.

In some embodiments, the outer shell 40 may be formed by a stamping process. It should be understood that stamping process is a production technology that, with the help of stamping equipment (presses) and tools (dies), exerts pressure on panel metal or non-metal to separate or deform it, thus obtaining a product with a certain shape, size and performance requirements.

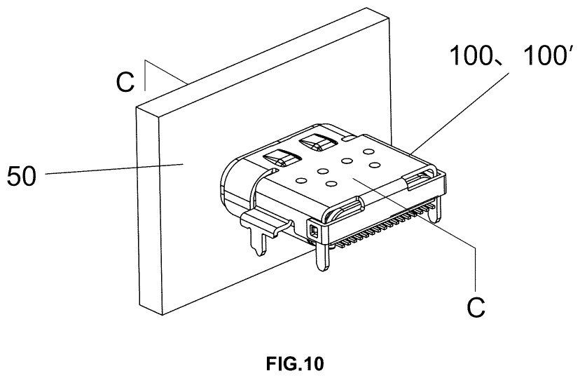

According to aspects of the present disclosure, referring to FIG. 10, an electronic system 200 may include a chassis 50 and an electrical connector (e.g., 100, 100′). The chassis 50 may include a port 51.

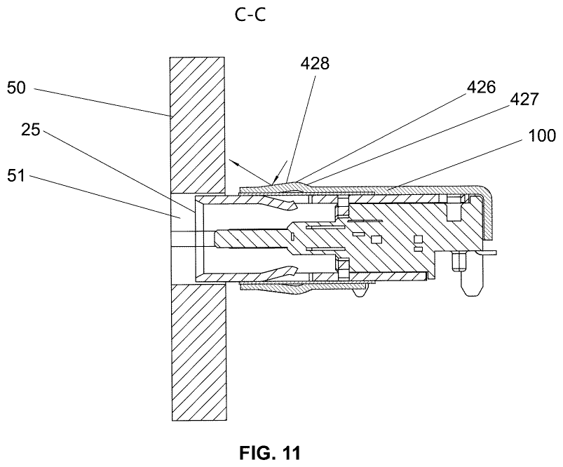

In some embodiments, referring to FIG. 11, a mating end 25 of the main shell 20 of the electrical connector 100 may be at least partially disposed in the port 51 of the chassis 50 such that the mating end of the terminal subassembly 10 of the electrical connector may be accessible through the port 51 of the chassis 50.

In some embodiments, the bulge 426 of the outer shell 40 may comprise a guiding portion 428 extending outwardly from the wall of the outer shell 40 corresponding to the first main shell sidewall and/or the second main shell sidewall and towards the rear end of the outer shell 40, forming a gap between the outer shell 40 and the MYLAR sheet or the first engaging portions. The guiding portion 428 may reflect light illuminating the outer shell 40 to the chassis 50 (see, e.g., the arrows shown in FIG. 11), thereby preventing light from leaking outside the electrical connector.

Various aspects are described in this disclosure, which include, but are not limited to, the following aspects:
1. An electrical connector, comprising: a terminal subassembly (e.g., 10) including a plurality of conductive elements (e.g., 13) and a subassembly housing (e.g., 11) holding the conductive elements (e.g., 13), the subassembly housing (e.g., 11) molded over the conductive elements (e.g., 13); and a main shell (e.g., 20) comprising a body (e.g., 23) enclosing a cavity, the body sleeved on an outer side of the terminal subassembly (e.g., 10), wherein the body (e.g., 23) of the main shell (e.g., 20) includes first engaging portions configured for engaging with a mating electrical connector in a mating direction (e.g., X), the first engaging portions extend from a first main shell sidewall (e.g., 22) and/or a second main shell sidewall (e.g., 28) opposite to each other in a vertical direction (e.g., Y) perpendicular to the mating direction (e.g., X), the first engaging portions protrude from the first main shell sidewall (e.g., 22) and/or the second main shell sidewall (e.g., 28) towards the cavity of the main shell (e.g., 20), the first engaging portions are partially separated from the first main shell sidewall (e.g., 22) and/or the second main shell sidewall (e.g., 28) of the main shell (e.g., 20), the electrical connector further comprises a member disposed on an outer side of the main shell (e.g., 20) and configured for blocking the first engaging portions.
2. The electrical connector according to aspect 1 or any other aspect, wherein the member includes a blocking film (e.g., 30) attached to an outer surface of the first main shell sidewall (e.g., 22) and/or the second main shell sidewall (e.g., 28) of the main shell (e.g., 20).
3. The electrical connector according to aspect 2 or any other aspect, wherein the member further includes an outer shell (e.g., 40) sleeved on the outer side of the main shell (e.g., 20) and configured to overlap with at least a portion of the blocking film (e.g., 30).
4. The electrical connector according to aspect 3 or any other aspect, wherein the first engaging portions comprise first beams (e.g., 21) configured to extend obliquely from the first main shell sidewall (e.g., 22) and/or the second main shell sidewall (e.g., 28) of the body (e.g., 23) of the main shell (e.g., 20) towards the cavity of the main shell (e.g., 20), the first beams (e.g., 21) are configured to have distal ends (e.g., 26) separated from the first main shell sidewall (e.g., 22) and/or the second main shell sidewall (e.g., 28), forming a gap between the first beams (e.g., 21) and the first main shell sidewall (e.g., 22) and/or the second main shell sidewall (e.g., 28).
5. The electrical connector according to any one of aspects 2 to 4 or any other aspect, wherein the body (e.g., 23) of the main shell (e.g., 20) is configured to have at least one second engaging portion, the main shell (e.g., 20) is secured in place at the outer side of the terminal subassembly (e.g., 10) by engaging the second engaging portion with a corresponding accommodation portion of the subassembly housing (e.g., 11), the second engaging portion is formed integrally with the main shell (e.g., 20).
6. The electrical connector according to aspect 5 or any other aspect, wherein the second engaging portion includes at least one second beam (e.g., 24) extending from the first main shell sidewall (e.g., 22) and/or the second main shell sidewall (e.g., 28), the second beam (e.g., 24) are recessed from the first main shell sidewall (e.g., 22) and/or the second main shell sidewall (e.g., 28) towards the cavity of the main shell (e.g., 20), such that the second beam (e.g., 24) is partially separated from the first main shell sidewall (e.g., 22) and/or the second main shell sidewall (e.g., 28), forming a gap between the second beam (e.g., 24) and the first main shell sidewall (e.g., 22) and/or the second main shell sidewall (e.g., 28).
7. The electrical connector according to aspect 6 or any other aspect, wherein the second beam (e.g., 24) is configured to be accommodated in a first accommodation portion (e.g., 14) formed adjacent a mating end of the subassembly housing (e.g., 11) of the terminal subassembly (e.g., 10), thereby positioning the main shell (e.g., 20) at the outer side of the terminal subassembly (e.g., 10).
8. The electrical connector according to aspect 7 or any other aspect, wherein the second engaging portion includes third beams (e.g., 27) configured to be provided at a tail end of the main shell (e.g., 20), the third beams (e.g., 27) are opposite to each other in a transverse direction perpendicular to both the mating direction (e.g., X) and the vertical direction (e.g., Y), the third beams (e.g., 27) are engaged with a second accommodation portion (e.g., 15) formed in the tail end of the subassembly housing (e.g., 11) of the terminal subassembly (e.g., 10) in a snap-fit manner, so that the main shell (e.g., 20) is fixedly sleeved on the outer side of the terminal subassembly (e.g., 10).
9. The electrical connector according to aspect 6 or any other aspect, where the blocking film (e.g., 30) is configured to have a shape and dimension configured to overlap with the first engaging portions and the second beam (e.g., 24).
10. The electrical connector according to aspects 3 or 4 or any other aspect, wherein in the mating direction (e.g., X), a mating end (e.g., 25) of the main shell (e.g., 20) extends beyond a mating end (e.g., 41) of the outer shell (e.g., 40), the mating end (e.g., 41) of the outer shell (e.g., 40) is disposed outside a mating end (e.g., 31) of the blocking film (e.g., 30).
11. The electrical connector according to aspects 3 or 4 or any other aspect, wherein a wall of the outer shell (e.g., 40) corresponding to the first main shell sidewall (e.g., 22) and/or the second main shell sidewall (e.g., 28) of the main shell (e.g., 20) comprises at least one bulge (e.g., 426) protruding outwardly, and the bulge (e.g., 426) overlaps with the first engaging portions of the main shell (e.g., 20).
12. The electrical connector according to aspect 11 or any other aspect, wherein the bulge (e.g., 426) comprises an slanting portion (e.g., 427) extending obliquely from the wall of the outer shell (e.g., 40) outwardly and towards a front end of the outer shell (e.g., 40), forming a gap between the outer shell (e.g., 40) and the blocking film (e.g., 30).
13. The electrical connector according to aspect 12 or any other aspect, wherein the bulge (e.g., 426) comprises a guiding portion (e.g., 428) extending obliquely from the wall outwardly and towards the rear end of the outer shell (e.g., 40), the guiding portion (e.g., 428) joins the slanting portion (e.g., 427), forming a predetermined angle therewith.
14. The electrical connector according to aspect 1 or any other aspect, wherein the member comprises an outer shell (e.g., 40) sleeved on the outer side of the main shell (e.g., 20).
15. The electrical connector according to aspect 14 or any other aspect, wherein the body (e.g., 23) of the main shell (e.g., 20) is configured to have at least one second engaging portion, the main shell (e.g., 20) is secured in place at the outer side of the terminal subassembly (e.g., 10) by engaging the second engaging portion with a corresponding accommodation portion of the subassembly housing (e.g., 11), the second engaging portion is formed integrally with the main shell (e.g., 20).
16. The electrical connector according to aspect 15 or any other aspect, wherein the second engaging portion comprises at least one second beam (e.g., 24) extending from the first main shell sidewall (e.g., 22) and/or the second main shell sidewall (e.g., 28), the second beam (e.g., 24) is recessed from the first main shell sidewall (e.g., 22) and/or the second main shell sidewall (e.g., 28) towards the cavity of the main shell (e.g., 20), such that the second beam (e.g., 24) is partially separated from the first main shell sidewall (e.g., 22) and/or the second main shell sidewall (e.g., 28), forming a gap between the second beam (e.g., 24) and the first main shell sidewall (e.g., 22) and/or the second main shell sidewall (e.g., 28).
17. The electrical connector according to aspect 16 or any other aspect, wherein the second beam (e.g., 24) is configured to be accommodated in a first accommodation portion (e.g., 14) formed adjacent a mating end of the subassembly housing (e.g., 11) of the terminal subassembly (e.g., 10), thereby positioning the main shell (e.g., 20) on the outer side of the terminal subassembly (e.g., 10).
18. The electrical connector according to aspect 17 and any other aspect, wherein the second engaging portion comprises third beams (e.g., 27) configured to be provided at a tail end of the main shell (e.g., 20), the third beams (e.g., 27) are opposite to each other in a transverse direction perpendicular to both the mating direction (e.g., X) and the vertical direction (e.g., Y), the third beams (e.g., 27) are engaged with a second accommodation portion (e.g., 15) formed in the tail end of the subassembly housing (e.g., 11) of the terminal subassembly (e.g., 10) in a snap-fit manner, so that the main shell (e.g., 20) is fixedly sleeved on the outer side of the terminal subassembly (e.g., 10).
19. The electrical connector according to aspect 16 or any other aspect, wherein in the mating direction (e.g., X), a mating end (e.g., 25) of the main shell (e.g., 20) extends beyond a mating end (e.g., 41) of the outer shell (e.g., 40), the first engaging portions and the second beam (e.g., 24) of the main shell (e.g., 20) overlap with the outer shell (e.g., 40).
20. The electrical connector according to aspect 16 or any other aspect, wherein the outer shell (e.g., 40) comprises a first portion (e.g., 42), a second portion (e.g., 43), and an intermediate connecting portion (e.g., 44) connecting the first portion (e.g., 42) with the second portion (e.g., 43), the first portion (e.g., 42) includes, in the vertical direction (e.g., Y), a first wall (e.g., 421) and a second wall (e.g., 422) opposite to the first wall (e.g., 421), the first wall (e.g., 421) and the second wall (e.g., 422) are configured to have shapes and dimensions configured to overlap with the first engaging portions and the second beam.
21. The electrical connector according to aspect 20 or any other aspect, wherein at least one of the first wall (e.g., 421) and the second wall (e.g., 422) includes at least one bulge (e.g., 426) protruding outwardly, the bulge (e.g., 426) comprises a slanting portion (e.g., 427) extending obliquely from a corresponding one of the first wall (e.g., 421) and the second wall (e.g., 422) outwardly and towards a front end of the outer shell (e.g., 40), forming a gap between the outer shell (e.g., 40) and the first engaging portions.
22. The electrical connector according to aspect 21 or any other aspect, wherein the bulge (e.g., 426) comprises a guiding portion (e.g., 428) extending obliquely from a corresponding one of the first wall (e.g., 421) and the second wall (e.g., 422) outwardly and towards the rear end of the outer shell (e.g., 40), the guiding portion (e.g., 428) joins the slanting portion (e.g., 427), forming a predetermined angle therewith.
23. The electrical connector according to any one of aspects 20 to 22 or any other aspects, wherein the first portion (e.g., 42) includes a first outer shell sidewall (e.g., 423) and a second outer shell sidewall (e.g., 424) opposite to each other and extending downwardly in a vertical direction (e.g., Y) respectively from ends of the first wall (e.g., 421) in a transverse direction (e.g., Z) perpendicular to the mating direction (e.g., X) and the vertical direction (e.g., Y), each of the first outer shell sidewall (e.g., 423) and the second outer shell sidewall (e.g., 424) includes a protrusion (e.g., 425).
24. The electrical connector according to aspect 23 or any other aspect, wherein openings (e.g., 431) are formed adjacent ends of the second portion (e.g., 43) in the transverse direction (e.g., Z); the intermediate connecting portion (e.g., 44) extends in a circular arc from a tail end of the first wall (e.g., 421) to allow the opening (e.g., 431) of the second portion (e.g., 43) to engage with the protrusion (e.g., 425) in a snap-fit manner.
25. An electronic system comprises a chassis (e.g., 50) and an electrical connector according to any one of aspects 1 to 24 or any other aspects. The chassis (e.g., 50) includes a port (e.g., 51). A mating end (e.g., 25) of the main shell (e.g., 20) of the electrical connector is at least partially disposed in the port (e.g., 51) of the chassis (e.g., 50) such that the mating end of the terminal subassembly (e.g., 10) of the electrical connector is accessible through the port (e.g., 51) of the chassis (e.g., 50).

Having thus described several aspects of several embodiments, it is to be appreciated that various alterations, modifications, and improvements will readily occur to those skilled in the art. Such alterations, modifications, and improvements are intended to be part of this disclosure and are intended to be within the spirit and scope of the invention. While the present teachings have been described in conjunction with various embodiments and examples, it is not intended that the present teachings be limited to such embodiments or examples. On the contrary, the present teachings encompass various alternatives, modifications, and equivalents, as will be appreciated by those of skill in the art.

As an example, although many creative aspects have been described above with reference to right angle connectors, it should be understood that the aspects of the present disclosure are not limited to right angle connectors. Any one of the creative features, whether alone or combined with one or more other creative features, can also be used for other types of electrical connectors, such as vertical connectors, etc.

Further, though some advantages of the present invention may be indicated, it should be appreciated that not every embodiment of the invention will include every described advantage. Some embodiments may not implement any features described as advantageous. Accordingly, the foregoing description and drawings are by way of example only.

Also, the technology described may be embodied as a method, of which at least one example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

All definitions, as defined and used, should be understood to control over dictionary definitions, definitions in documents incorporated by reference, and/or ordinary meanings of the defined terms.

In the description of the present disclosure, it is to be understood that orientation or positional relationships indicated by orientation words “front”, “rear”, “upper”, “lower”, “left”, “right”, “transverse direction”, “vertical direction”, “perpendicular”, “horizontal”, “top”, “bottom” and the like are shown based on the accompanying drawings, for the purposes of the case in describing the present disclosure and simplification of its descriptions. Unless stated to the contrary, these orientation words do not indicate or imply that the specified apparatus or element has to be specifically located, and structured and operated in a specific direction, and therefore, should not be understood as limitations to the present disclosure. The orientation words “inside” and “outside” refer to the inside and outside relative to the contour of each component itself.

For facilitating description, the spatial relative terms such as “on”, “above”, “on an upper surface of” and “upper” may be used here to describe a spatial position relationship between one or more components or features and other components or features shown in the accompanying drawings. It should be understood that the spatial relative terms not only include the orientations of the components shown in the accompanying drawings, but also include different orientations in use or operation.

It should be noted that the terms used herein are for describing specific embodiments, and are not intended to limit the exemplary embodiments according to the present application. As used herein, an expression of a singular form includes an expression of a plural form unless otherwise indicated. In addition, it should also be understood that when the terms “including” and/or “comprising” are used herein, it indicates the presence of features, steps, operations, parts, components and/or combinations thereof.

The indefinite articles “a” and “an,” as used in the specification and in the claims, unless clearly indicated to the contrary, should be understood to mean “at least one.”

The phrase “and/or,” as used in the specification and in the claims, should be understood to mean “either or both” of the elements so conjoined, elements that are conjunctively present and disjunctively present in other cases. Multiple elements listed with “and/or” should be construed in the same fashion, “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used in the specification and in the claims, “or” should be understood to have the same meaning as “and/or” as defined above. For example, when separating items in a list, “or” or “and/or” shall be interpreted as being inclusive, the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally Including other elements); etc.

In the claims, as well as in the specification above, all transitional phrases such as “comprising,” “including,” “carrying,” “having,” “containing,” “involving,” “holding,” “composed of,” and the like are to be understood to be open-ended, to mean including but not limited to. For example, a process, method, system, product or device that contains a series of steps or units need not be limited to those steps or units that are clearly listed, instead, it may include other steps or units that are not clearly listed or are inherent to these processes, methods, products or devices. Only the transitional phrases “consisting of” and “consisting essentially of” shall be closed or semi-closed transitional phrases, respectively.

The claims should not be read as limited to the described order or elements unless stated to that effect. It should be understood that various changes in form and detail may be made by one of ordinary skill in the art without departing from the spirit and scope of the appended claims. All embodiments that come within the spirit and scope of the following claims and equivalents thereto are claimed.

In the claims, as well as in the specification above, use of ordinal terms such as “first,” “second,” “third,” etc. does not by itself connote any priority, precedence, or order of one element over another or the temporal order in which acts of a method are performed, but are used merely as labels to distinguish one element having a certain name from another element having a same name (but for use of the ordinal term) to distinguish the elements.

What is claimed is:

1. A receptacle connector configured for use in an electronic device, the receptacle connector comprising:
a main shell comprising a cavity with a front opening, a first wall, a first engaging portion connected to the first wall and protruding towards the cavity and configured to engage a mating connector, and a first gap between the first wall and the first engaging portion;
a terminal subassembly disposed in the cavity of the main shell, the terminal subassembly comprising a subassembly housing and a plurality of conductive elements held by the subassembly housing, each of the plurality of conductive elements comprising a mating end, a tail end extending out of the subassembly housing, and an intermediate portion between the mating end and the tail end; and
a member disposed outside the main shell and configured for blocking light from exiting the main shell through the front opening.

2. The receptacle connector of claim 1, wherein:
the member comprises a film overlapping with the first engaging portion and the first gap.

3. The receptacle connector of claim 2, wherein:
the film is a MYLAR sheet.

4. The receptacle connector of claim 2, wherein:
the member comprises an outer shell having a front portion disposed outside the film.

5. The receptacle connector of claim 4, wherein:
the main shell comprises a second engaging portion connected to the first wall and protruding toward inside the main shell, and a second gap between the first wall and the second engaging portion; and
the film overlaps with the second engaging portion and the second gap.

6. The receptacle connector of claim 5, wherein:
the subassembly housing comprises a first accommodation portion configured for engaging the second engaging portion of the main shell; and
the first accommodation portion is disposed closer to the mating ends of the plurality of conductive elements than the tail ends of the plurality of conductive elements.

7. The receptacle connector of claim 6, wherein:
the front portion of the outer shell comprises a bulge disposed closer to the mating ends of the plurality of conductive elements than the first accommodation portion of the subassembly housing.

8. The receptacle connector of claim 7, wherein the bulge comprises:
a guiding portion extending towards outside the outer shell and extending obliquely towards a rear end of the outer shell; and
a slanting portion extending towards outside the outer shell and extending obliquely towards a front end of the outer shell and joining the guiding portion.

9. The receptacle connector of claim 8, wherein:
the first engaging portion of the main shell comprises a first beam having a proximal end connected to the first wall and a distal end configured to engage the mating connector;
the second engaging portion of the main shell comprises a second beam configured for engaging the first accommodation portion and a third beam disposed closer to the tail ends of the plurality of conductive elements than the second beam; and
the subassembly housing comprises a second accommodation portion configured for engaging the third beam.

10. The receptacle connector of claim 7, wherein:
the front portion of the outer shell encloses a respective portion of the main shell and comprises a plurality of bulges.

11. An electronic system comprising:
a chassis comprising a port; and
the receptacle connector of claim 1, the receptacle connector disposed in the chassis, wherein the member is configured for blocking light from exiting the chassis through the port.

12. A receptacle connector configured for use in an electronic device, the receptacle connector comprising:
a main shell comprising a first wall, a first engaging portion connected to the first wall and protruding towards inside the main shell and configured to engage a mating connector, a first gap between the first wall and the first engaging portion, a second engaging portion connected to the first wall and protruding towards inside the main shell, and a second gap between the first wall and the second engaging portion;
a terminal subassembly disposed in the main shell, the terminal subassembly comprising a subassembly housing and a plurality of conductive elements held by the subassembly housing, each of the plurality of conductive elements comprising a mating end, a tail end extending out of the subassembly housing, and an intermediate portion between the mating end and the tail end, the subassembly housing comprising a first accommodation portion disposed closer to the mating ends of the plurality of conductive elements than the tail ends of the plurality of conductive elements, the first accommodation portion configured for engaging the second engaging portion of the main shell; and
an outer shell comprising a front portion disposed outside the first engaging portion of the main shell and comprising a plurality of bulges extending towards outside the outer shell.

13. The receptacle connector of claim 12, wherein each of the plurality of bulges of the outer shell comprises:
a guiding portion extending towards a rear end of the outer shell; and
a slanting portion extending towards a front end of the outer shell and joining the guiding portion.

14. The receptacle connector of claim 12, wherein:
the first engaging portion is aligned with respective bulges of the plurality of bulges in a vertical direction perpendicular to a mating direction of the receptacle connector.

15. The receptacle connector of claim 14, wherein:
the plurality of bulges are disposed closer to the mating ends of the plurality of conductive elements than the first accommodation portion of the subassembly housing in the mating direction of the receptacle connector.

16. The receptacle connector of claim 12, wherein:
the main shell comprises a second wall opposite the first wall;
the first engaging portion comprises portions extending from the first and second walls, respectively; and
the receptacle connector further comprises:
a first film disposed between the portion of the first engaging portion extending from the first wall of the main shell and the front portion of the outer shell, and
a second film disposed between the portion of the first engaging portion extending from the second wall of the main shell and the front portion of the outer shell.

17. The receptacle connector of claim 16, wherein:
the first and second films are MYLAR sheets.

18. The receptacle connector of claim 16, wherein:
the second engaging portion comprises portions extending from the first and second walls, respectively;
the first film is disposed between the portion of the second engaging portion extending from the first wall of the main shell and the front portion of the outer shell; and
the second film is disposed between the portion of the second engaging portion extending from the second wall of the main shell and the front portion of the outer shell.

19. A method of manufacturing a receptacle connector, comprising:
providing a terminal subassembly comprising a plurality of conductive elements held by a subassembly housing, each of the plurality of conductive elements comprising a mating end, a tail end extending out of the subassembly housing, and an intermediate portion between the mating end and the tail end, the subassembly housing comprising a first accommodation portion disposed closer to the mating ends of the plurality of conductive elements than the tail ends of the plurality of conductive elements;
providing a main shell comprising a first wall, a first engaging portion connected to the first wall and protruding towards inside the main shell and configured to engage a mating connector, a first gap between the first wall and the first engaging portion, a second engaging portion connected to the first wall and protruding towards inside the main shell, and a second gap between the first wall and the second engaging portion;
disposing the terminal subassembly in the main shell such that the first accommodation portion of the subassembly housing engages the second engaging portion of the main shell; and
disposing a film on the first wall of the main shell such that the film overlaps with the first and second engaging portions and the first and second gaps.

20. The method of claim 19, further comprising:
providing an outer shell comprising a front portion having a bulge; and
disposing the outer shell outside the main shell such that the bulge of the front portion is substantially aligned with the first engaging portion in a vertical direction perpendicular to a mating direction of the receptacle connector.
